(19) United States
(12) Patent Application Publication
(10) Pub. No.: US 2026/0211795 A1
(43) Pub. Date: Jul. 23, 2026

(54) METHODS FOR CONCURRENT VULNERABILITY DETECTION BASED ON CODE CONCURRENCY PROPERTY GRAPHS

(71) Applicants: BEIHANG UNIVERSITY, Beijing (CN); HANGZHOU INNOVATION INSTITUTE OF BEIHANG UNIVERSITY, Hangzhou (CN)

(72) Inventors: Xiang GAO, Beijing (CN); Hailong SUN, Beijing (CN); Yunlong MA, Beijing (CN); Yu GUO, Beijing (CN)

(73) Assignees: BEIHANG UNIVERSITY, Beijing (CN); HANGZHOU INNOVATION INSTITUTE OF BEIHANG UNIVERSITY, Hangzhou (CN)

(21) Appl. No.: 19/432,920

(22) Filed: Dec. 24, 2025

(30) Foreign Application Priority Data
Dec. 24, 2024 (CN) 202411910943.8

(51) Int. Cl. G06F 11/362; G06F 11/3604

(52) U.S. Cl. CPC G06F 11/364; G06F 11/3612

(57) ABSTRACT

The present disclosure relates to a method for concurrency vulnerability detection based on code concurrency property graphs. The method adopts a vulnerability detection tool CONCODEQL, and includes S1, initializing a code property graph (CPG) and identifying one or more critical nodes based on a source code to be tested; S2, constructing one or more concurrency relationships by traversing the CCPG. The present disclosure overcomes a deficiency of existing static code detection manners based on structured denotations, which have difficulty in identifying complex concurrent vulnerabilities. The DSL based on the CCPG supports detection of different types of concurrent vulnerabilities, thereby improving the extensibility of the tool. By combining capabilities of the CCPG, false positive rates and false negative rates of traditional data race detection manners can be effectively reduced, and detection capabilities for complex concurrency problems can be enhanced.

### CROSS-REFERENCE TO RELATED APPLICATIONS

This application claims priority to the Chinese Patent Application No. 202411910943.8, filed on Dec. 24, 2024, the contents of which are hereby incorporated by reference.

### TECHNICAL FIELD

The present disclosure generally relates to a field of computer software security technology, and in particular to methods for concurrency vulnerability detection based on code concurrency property graphs.

### BACKGROUND

To improve software performance, an increasing count of concurrent programming models are incorporated into modern software applications. These concurrent programs can fully utilize multi-core CPUs to accelerate computation, significantly improving execution speed. However, interleaved execution of threads in concurrent programs introduces considerable non-determinism, which may lead to many vulnerabilities specific to this environment. This non-determinism makes these vulnerabilities difficult to detect and fix.

In response to the above background, a large amount of research work is dedicated to detecting various vulnerabilities in concurrent programs. Researchers have explored detecting data races, synchronization errors (e.g., deadlocks and unreleased locks), memory-related vulnerabilities in concurrent scenarios (e.g., double-free and use-after-free vulnerabilities), or the like. Overall, detection manners for different types of vulnerabilities vary significantly. The data race detection primarily focuses on unsafe access to shared memory, while synchronization error detection emphasizes the correctness of synchronization logic.

From a technical perspective, many researchers focus on dynamic analysis manners, which combine testing with formal reasoning to report concurrency errors by tracking all possible valid reorderings under different program inputs. Due to limitations of exhaustive computational complexity, many techniques based on partial orders have emerged later. Currently, much work is dedicated to constructing efficient and computable weak partial orders. Although these manners can precisely detect concurrent vulnerabilities, they all suffer from inherent drawbacks of dynamic analysis, i.e., significant performance overhead and limited coverage.

In contrast, static analysis tools available for detecting concurrent vulnerabilities are relatively few. Notable tools in this field include RacerD and Coderrect. Both tools primarily focus on data race issues and achieve concurrent vulnerability detection by analyzing access patterns of shared variables. Compared to the analysis of sequential programs, a main challenge of static analysis for detecting concurrent vulnerabilities lies in analyzing memory access behavior in concurrent scenarios and determining parallel relationships between statements. For memory access analysis, current manners mainly use data flow analysis and pointer analysis. Both manners are based on a value flow graph (VFG), respectively used for capturing semantic relationships within and between threads and for performing memory access analysis. For parallel relationship analysis, the main work includes lock-set-based manners and static happens-before analysis. Lock-set-based manners (e.g., Locksmith) detect concurrent vulnerabilities by determining whether all accesses to a shared location are always protected by locks. Static happens-before analysis represents a program as an abstract graph of threads to infer parallel relationships between nodes. Current manners typically combine these two techniques to more accurately determine parallel relationships between statements.

Subsequently, some static program analysis tools supporting concurrent error detection have emerged, such as CodeQL and Joern. These tools first convert source codes into a structured representation (i.e., relational data or a graph) and store the structured representation in a database, then use a domain-specific language (DSL) to query the database. This mechanism allows users to define complex error detection patterns and implement detection through queries.

CodeQL is a static code analysis tool launched by GitHub, widely used for security checks and vulnerability research. A core concept of CodeQL is treating code as data. By converting a codebase into a queryable database, developers write query statements to detect security vulnerabilities, potential vulnerabilities, and other quality issues in the code. Although CodeQL performs excellently in detecting conventional security vulnerabilities and logic defects, CodeQL is not mature in detecting concurrency errors (such as race conditions, deadlocks). A fundamental reason is that an underlying code property graph (CPG) on which CodeQL relies cannot adequately express concurrency relationships. A core data representation manner of the CPG primarily focuses on syntactic structure, control flow, and data flow of code, and cannot directly model threads, locks, and interactions thereof. Detection of concurrency errors typically requires effective modeling of the following problems:

Synchronization and communication between threads: such as acquisition and release of locks, use of semaphores, or the like.

Race conditions: a plurality of threads simultaneously access a shared resource and an access order affects a program result.

Deadlock: different threads enter a mutual waiting state due to resource competition.

Because the CPG lacks an intuitive representation of the above concurrency semantics, analytical capabilities of CodeQL are limited for such problems. Although functionality of CodeQL can be enhanced by extending logic and rules, native capabilities of CodeQL are not optimized for concurrency problems. This means that detection capabilities of CodeQL for concurrency errors are weak, with both recall rate and accuracy rate being low.

Coderrect is a static analysis tool specifically designed for concurrent programs, aiming to help developers identify concurrency problems in code, and is particularly adept at detecting data race issues. Coderrect supports mainstream concurrency-related interfaces, such as OpenMP, Pthreads, and C++ standard thread libraries. Coderrect can quickly discover and resolve potential problems during a development phase through static analysis techniques.

Although detection capabilities of Coderrect for data races are very strong, functionality of Coderrect primarily focuses on such issues. Support of Coderrect for other types of concurrency errors (such as deadlocks, livelocks, race conditions) and concurrent vulnerabilities is limited. This means that Coderrect cannot comprehensively cover all potential risks in concurrent programming, and developers may need to combine other tools for more comprehensive analysis.

Therefore, a concurrency vulnerability detection method based on a code concurrency property graph (CCPG) is urgently needed to achieve more comprehensive analysis.

### SUMMARY

One or more embodiments of the present disclosure provide a concurrency vulnerability detection method based on a code concurrent property graph. The goal is to solve limitations of existing work, such as poor scalability and low accuracy, to implement a more universal and mature concurrency vulnerability detection tool, thereby improving software security. Specifically, main problems solved include:
(1) Existing static code detection manners based on structured representations lack representation of features of concurrent programs, making it difficult to identify complex concurrency vulnerabilities. The present disclosure proposes the CCPG, which can effectively express various relationships and features in source code of a concurrent program.
(2) Existing concurrency vulnerability detection tools have poor extensibility and can only target specific vulnerabilities or certain vulnerabilities. The present disclosure designs a domain-specific language (DSL) for detecting different types of vulnerabilities based on the CCPG.
(3) Traditional data race detection manners lack comprehensive analysis of various syntactic relationships, memory access patterns, and concurrency mechanisms in source code, leading to false positives and false negatives. The present disclosure designs a domain-specific language (DSL) specifically for defining complex concurrency rules based on the CCPG, thereby enhancing identification of subtle concurrency problems that traditional tools may overlook.

One or more embodiments of the present disclosure provide a concurrency vulnerability detection method based on a code concurrent property graph (CCPG). The method adopts a vulnerability detection tool CONCODEQL and includes the following processes: S1, initializing a code property graph (CPG) and identifying one or more critical nodes based on a source code to be tested, including: initializing the CCPG and identifying one or more critical nodes within a concurrent program of the CCPG based on the source code to be tested, the CPG, and a value flow graph (VFG). S2, constructing one or more concurrency relationships by traversing the CCPG, includes: traversing the initialized CCPG, constructing a thread-aware context, and sequentially performing flow-sensitive happens-before analysis, inter-procedural lock-set analysis, and enhanced concurrent pointer analysis based on the thread-aware context, and constructing the one or more concurrency relationships for the one or more critical nodes in the CCPG; performing the thread-aware analysis and thread-aware, flow-sensitive analysis; wherein the performing the thread-aware analysis includes: defining the thread-aware context for a critical node as one or more paths from a main entry node to the critical node that collectively encompass all ancestor threads and a current thread; denoting a thread-aware context along a specific path as c=[n₁, n₂, . . . , nₘ], wherein each element represents a concurrency behavior node, all thread-aware contexts of a critical node nᵢ are represented as a two-dimensional matrix

$$C = [ {c}_{1}^{i} , {c}_{2}^{i} , … , {c}_{k}^{i} ] ,$$

and k denotes a count of feasible execution paths from the main entry node to the critical node. The flow-sensitive happens-before analysis includes: constructing one or more happens-before edges based on the thread-aware context to determine an execution order between a first node nᵢ and a second node nⱼ; for the first node nᵢ, constructing a fork set for each thread-aware context of the first node nᵢ; defining the fork set as

$${fs}_{k}^{i} = \{ n ∈ {c}_{k}^{i} \vert λ ( n ) = Fork ( t ) ⋀ JOIN ( t ) ∉ {c}_{k}^{i} \} ,$$

wherein the fork set consists of one or more FORK nodes whose corresponding threads have not yet been joined within the thread-aware context, the CONCODEQL checks whether fork sets of the first node nᵢ and the second node nⱼ have any overlap, an overlap between the fork sets of the first node nᵢ and the second node nⱼ indicates that the first node nᵢ and the second node nⱼ execute concurrently, and a hp relationship between the first node nᵢ and the second node nⱼ is determined using following formula:

$$h p ( {n}_{i} , {n}_{j} ) = \{ \begin{matrix}0 , & {∧}_{{k}_{1} ∈ [ 1 , {k}_{i} ] ; {k}_{2} ∈ [ 1 , {k}_{j} ]} {fs}_{{k}_{1}}^{i} ⋂ {fs}_{{k}_{2}}^{j} == ∅ \\ 1 , & otherwise\end{matrix} .$$

performing the inter-procedural lock-set analysis includes: analyzing the happens-before relationship is insufficient to determine whether the first node nᵢ and the second node nⱼ are capable of concurrent execution, because the first node nᵢ and the second node nⱼ are capable of being protected by locks; for the first node nᵢ and the second node nⱼ, performing the inter-procedural lock-set analysis is performed to determine whether the first node nᵢ and the second node nⱼ are protected by a same lock; for the first node nᵢ, the CONCODEQL constructs a lock set for each thread-aware context of the first node nᵢ; wherein the lock set is

$${ls}_{k}^{i} = \{ n ∈ {c}_{k}^{i} \vert λ ( n ) = acquire\_lock ( l ) ⋀ release\_lock ( l ) ∉ {c}_{k}^{i} \} ,$$

the lock set consists of one or more lock-acquisition nodes whose corresponding locks have not yet been released within the thread-aware context; the CONCODEQL determines whether the first node nᵢ and the second node nⱼ are protected by a same lock by checking whether lock sets of the first node nᵢ and the second node nⱼ have any overlap; a psl relationship between the first node nᵢ and the second node nⱼ is determined using following formula:

$$psl ( {n}_{i} , {n}_{j} ) = \{ \begin{matrix}0 , & {∧}_{{k}_{1} ∈ [ 1 , {k}_{i} ] ; {k}_{2} ∈ [ 1 , {k}_{j} ]} {ls}_{{k}_{1}}^{i} ⋂ {ls}_{{k}_{2}}^{j} == ∅ \\ 1 , & otherwise\end{matrix} ;$$

performing the enhanced concurrent pointer analysis, wherein the enhanced concurrent pointer analysis includes global variable analysis and struct analysis. The global variable analysis represents a precise analysis of global variables, designed by analyzing the CCPG and the VFG, including: identifying all global variable declarations by traversing the CCPG, thereby obtaining a global variable set; reconstructing connections between global variables and local variables, and determining one or more global variable aliases through flow-sensitive pointer analysis. The struct analysis includes: for an access node of a struct, simply obtaining a specific attribute accessed by the access node through the CPG using a regular expression-based determination, wherein the CONCODEQL analyzes the CCPG and the VFG, and adjusting a representation of the struct in the flow-sensitive pointer analysis to the specific attribute. The thread-aware, flow-sensitive analysis includes: traversing the CCPG, and constructing the thread-aware context for each critical node; wherein the CONCODEQL obtains the all main entry nodes from the CCPG and initializes the thread-aware contexts of the main entry nodes as empty; during a main loop, if a current node with a current thread-aware context is accessed, the CONCODEQL directly terminates the loop; otherwise, the CONCODEQL traverses the CCPG along a thread-lifecycle edge and control-flow edge, if a current node n is a FORK node that creates a new thread, a thread-aware context of an entry node n′ of the new thread is initialized to each thread-aware context previously added to the current node n, and the new thread is created; if the current node n is not a FORK node, the CONCODEQL traversal proceeds along the control-flow edge, and the thread-aware context of the current node n is propagated to a successor node; the thread-aware context for each critical node is utilized for the flow-sensitive happens-before analysis and the inter-procedural lock-set analysis. The CONCODEQL traversing any pair of threads and checks whether memory access nodes of the thread pair execute concurrently based on the thread-aware context of each critical node, including: if the first node nᵢ and the second node nⱼ simultaneously satisfy that: 1) the first node nᵢ and the second node nⱼ access a same memory location; 2) the first node nᵢ and the second node nⱼ execute concurrently; 3) the first node nᵢ and the second node nⱼ are not protected by a same lock, the CONCODEQL adding an HP edge between the first node nᵢ and the second node nⱼ; wherein an updated CCP is generated when the loop terminates. S3, detecting a concurrency vulnerability based on a domain-specific language, includes: designing one or more query interfaces of the domain-specific language for different types of concurrency vulnerabilities, performing queries on the CCPG to conduct concurrency vulnerability detection, and outputting detected concurrency vulnerabilities as a vulnerability report.

One or more embodiments of the present disclosure provide a concurrency vulnerability detection method based on a code concurrent property graph. The S1 includes: the CONCODEQL generating the CPG and the VFG from the source code, identifying concurrency-related interfaces from the CPG, and defining the CCPG for the concurrent program by integrating information derived from the VFG; wherein nodes in the CCPG include memory access nodes, concurrency behavior nodes, and other nodes; the memory access nodes are configured to represent accesses to memory in the source code; the concurrency behavior nodes correspond to concurrency-related interfaces in the source code and the concurrency behavior nodes include thread organization nodes and synchronization logic nodes; the thread organization nodes include the FORK nodes, JOIN nodes, DETACH nodes, and EXIT nodes; the synchronization logic nodes include lock-acquisition (ACQUIRE) nodes and lock-release (RELEASE) nodes; the other nodes are critical nodes representing a basic operational logic of a program; edges in the CCPG include a code property graph edge and a concurrency relationship edge; the code property graph edge includes an abstract syntax tree edge, the control-flow edge, and a dependency edge; the concurrency relationship edge includes a thread-lifecycle edge and an May-Happens-Parallel edge; the thread-lifecycle edge includes an edge from the FORK node to a corresponding thread entry and edges from a thread exit to the JOIN node; the edge indicating possible concurrent execution connects critical nodes from different threads that execute concurrently, wherein the CONCODEQL only connects and accesses the one or more critical nodes with a same memory location.

One or more embodiments of the present disclosure provide a concurrency vulnerability detection method based on a code concurrent property graph. The S3 includes: defining the domain-specific language by a grammar L={V_{T}, V_{N}, P, S}, wherein V_{T} is a set of terminal symbols, V_{N} is a set of non-terminal symbols, P is a production rule set that serves as a primary structural unit of the grammar, the production rule set includes production rules, each production rule is expressed as α::=β, the production rules describe a process for combining elements from the terminal symbol set and non-terminal symbol set into strings, S is a start symbol; designing the domain-specific language by utilizing and extending query statements used in a CodeQL domain-specific language; in the domain-specific language, <query> represents the start symbol in the definition and serves as an entry point of the domain-specific language; <var_decls> denotes a variable declaration, including a basic variable type and a built-in type <built-in type>; <condition> defines constraints within a query; <returns> specifies a value returned by the query; wherein a domain specificity of the domain-specific language in a concurrency field is reflected in structure <built-in type> and <concurrent_relation_condition>; <concurrent_relation_condition> includes <access_condition>, <hb_relationship>, and <lock condition>, configured to process the enhanced concurrent pointer analysis, the flow-sensitive happens-before analysis, and the inter-procedural lock-set analysis, respectively; the inter-procedural lock-set analysis includes an IS_PROTECTED_BY manner and an IS_AUTOMATICALLY_PROTECTED_BY manner, the IS_PROTECTED_BY manner determines whether two variables a protected by a same lock, and the IS_AUTOMATICALLY_PROTECTED_BY manner checks whether operations are within a same critical section to ensure atomicity.

One or more embodiments of the present disclosure provide a concurrency vulnerability detection method based on a code concurrent property graph, providing a technical foundation for developing a more universal and mature concurrency vulnerability detection tool and significantly improving software security and reliability. Beneficial effects include: (1) By introducing the CCPG, various relationships and features in source code to be tested can be comprehensively expressed, overcoming deficiencies of existing static code detection methods based on structured representations, which have difficulty identifying complex concurrency vulnerabilities. (2) Supporting detection of different types of concurrency vulnerabilities greatly enhances tool extensibility, enabling the tool to adapt to a wider range of application scenarios. (3) By combining capabilities of the CCPG, syntactic relationships, memory access patterns, and concurrency mechanisms in source code can be comprehensively analyzed, thereby effectively reducing false positive and false negative rates of traditional data race detection manners and enhancing detection capability for complex concurrency problems.

### BRIEF DESCRIPTION OF THE DRAWINGS

FIG. 1 is a flowchart of an overall working process of CONCODEQL according to some embodiments of the present disclosure.

FIG. 2 is a schematic diagram of thread-aware analysis according to some embodiments of the present disclosure.

FIG. 3 is a flowchart of a process for constructing a thread-aware context according to some embodiments of the present disclosure.

FIG. 4 is a schematic diagram of a main framework of a domain-specific language (DSL) according to some embodiments of the present disclosure.

FIG. 5 is a schematic diagram of a screenshot of concurrency-specific components of a domain-specific language (DSL) according to some embodiments of the present disclosure.

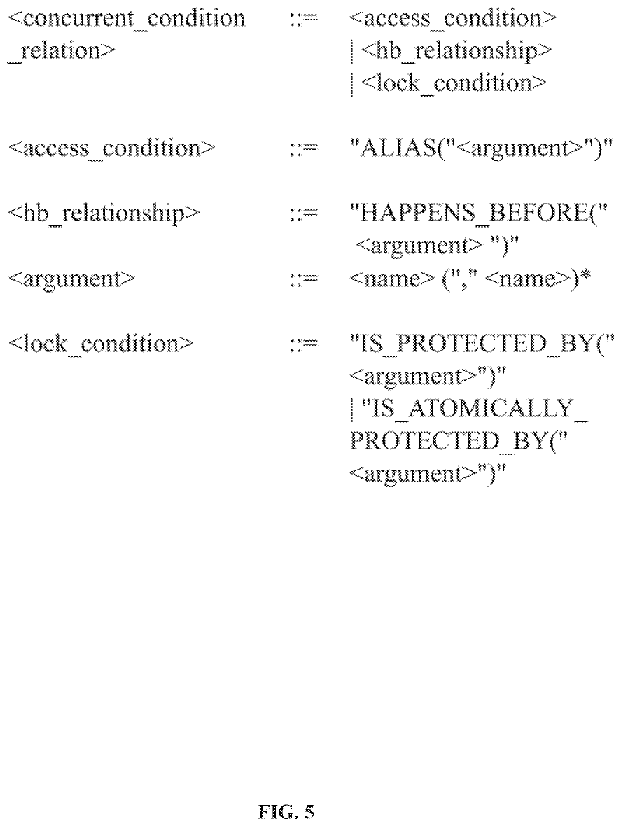

FIG. 6 is a schematic diagram of a screenshot of an exemplary query for data race detection according to some embodiments of the present disclosure.

### DETAILED DESCRIPTION

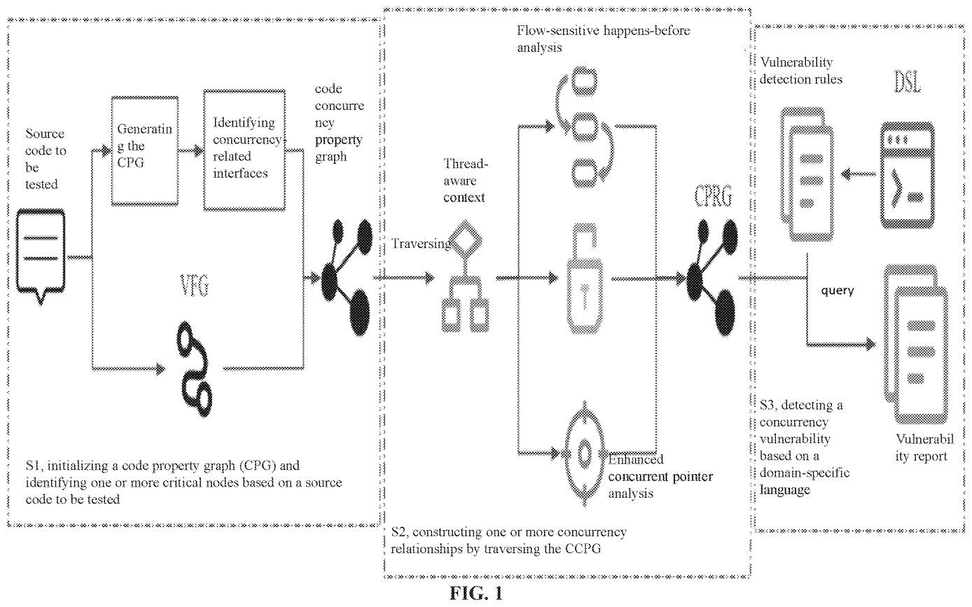

FIG. 1 is a flowchart of an overall working process of CONCODEQL according to some embodiments of the present disclosure. As shown in FIG. 1, S1-S3 are performed by the vulnerability detection tool CONCODEQL.

In S1, a code property graph (CPG) is initialized, and one or more critical nodes are identified based on a source code to be tested.

In some embodiments, the vulnerability detection tool CONCODEQL initializes the CCPG and identifies one or more critical nodes within a concurrent program of the CCPG based on the source code to be tested, the CPG, and a value flow graph (VFG).

The vulnerability detection tool CONCODEQL (hereinafter referred to as CONCODEQL) is a static code analysis tool that can detect, analyze, and query concurrent vulnerabilities in a concurrent program.

The source code to be tested refers to original code that requires concurrency vulnerability detection.

The code property graph (CPG) is a structured representation form characterizing property flow transfer of a program in the source code.

In some embodiments, the CPG is a graph structure. In the CPG, a node represents an element of the source code (e.g., a function, a statement, an expression), and an edge represents a relationship between elements (e.g., syntactic nesting, control flow transfer, data dependency).

The value flow graph (VFG) is a structured representation form characterizing value flow transfer of a program in the source code.

In some embodiments, the VFG is a graph structure. In the VFG, a node represents a value of an element of the source code (e.g., a variable, a constant, a memory address), and an edge represents a dependency relationship between values (e.g., assignment, function parameter passing).

The CCPG is a structured representation form characterizing execution logic and interaction relationships of a concurrent program in the source code.

In some embodiments, the vulnerability detection tool CONCODEQL initializes the CCPG and identifies one or more critical nodes within a concurrent program of the CCPG based on the source code to be tested, the CPG, and the VFG.

The critical node is a program point that is significant for inference and identification of concurrent vulnerabilities in concurrent analysis.

In some embodiments, the CONCODEQL identifies critical nodes from the CCPG according to a preset requirement. The preset requirement is preset according to manual experience. For example, the CONCODEQL uses a memory access node and a concurrency behavior node in the CCPG as critical nodes.

More descriptions about the CPG, the memory access node, and the concurrency behavior node may be found in related descriptions later.

In S2, the CCPG is traversed to construct a concurrency relationship, including: traversing the initialized CCPG, constructing a thread-aware context, and sequentially performing flow-sensitive happens-before analysis, inter-procedural lock-set analysis, and enhanced concurrent pointer analysis based on the thread-aware context, and constructing the one or more concurrency relationships for the one or more critical nodes in the CCPG.

The concurrency relationship refers to a relationship in the CCPG that describes possible parallel execution timing relationships between nodes (e.g., critical nodes) in different threads.

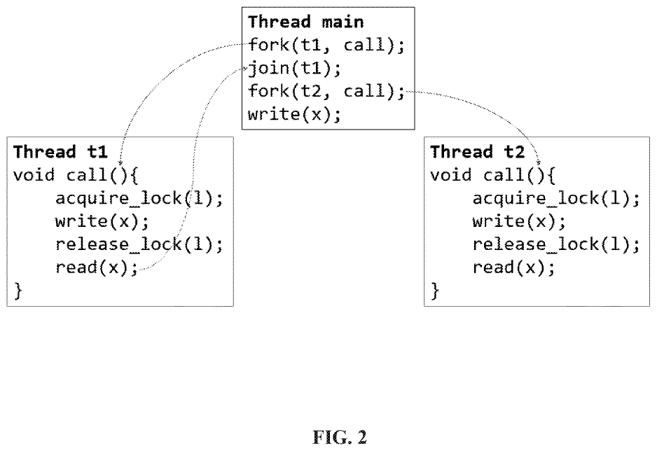

FIG. 2 is a schematic diagram of thread-aware analysis according to some embodiments of the present disclosure. As shown in FIG. 2, Thread main, Thread t1, and Thread t2 are three threads. fork(t1, call), fork(t2, call), join(t1), join(t2), acquire_lock(1), release_lock(1), write(x), read(x), Thread main, and void call( ) are critical nodes. The thread main is a main thread and is also the main entry node of the main thread. Thread t1 or t1 is a thread where t1 is located. Thread t2 or t2 is a thread where t2 is located. Void call( ) is a function call node. fork( ) (e.g., fork(t1, call), fork(12, call)) is a type of FORK node in a concurrency behavior node. join( ) (e.g., join(t1), join(t2)) is a type of JOIN node in a concurrency behavior node. acquire_lock( ) (e.g., acquire_lock(1)) is a type of lock-acquisition node ACQUIRE, representing an operation of successfully acquiring a mutex lock. release_lock( ) (e.g., release_lock(1)) is a type of lock-release node RELEASE, representing an operation of successfully releasing a mutex lock. write( ) (e.g., write(x)) is a type of memory access nodes, representing an operation of writing data to a memory location. read( ) (e.g., read(x)) is a type of memory access node, representing an operation of reading data from a memory location. x is a global variable.

The thread-aware context for a critical node is defined as one or more paths from a main entry node to the critical node that collectively encompass all ancestor threads and a current thread; the thread-aware context is each path from a main entry node to the critical node. The main entry node refers to a starting point of program execution in source code, such as a main function Thread main. The ancestor thread is a thread that creates the current thread or any parent thread of the current thread from the main entry node (e.g., the main function) to the critical node. The current thread is a currently focused thread among a plurality of threads where the critical node is located. For example, as shown in FIG. 2, a critical node is write(x) in thread t1. The current thread is then t1. Because t1 is directly created by the main thread through fork(t1, call), ancestor threads of the critical node include Thread main.

In some embodiments, there are a plurality of paths from the main entry node to the critical node (e.g., due to the existence of conditional statements, there are usually a plurality of control flow paths from a main entry node to a critical node). Each path includes all critical nodes of the current thread and the plurality of ancestor threads.

In some embodiments, a thread-aware context from the main entry node to the critical node along a specific path (e.g., one path of the plurality of paths from the main entry node to the critical node) is denoted as c=[n₁, n₂, . . . , nₘ], wherein c is the thread-aware context from the main entry node to the critical node along the specific path. Each element (e.g., n₁) represents a concurrency behavior node. All thread-aware contexts of a critical node n; are represented as a two-dimensional matrix

$$C = [ {c}_{1}^{i} , {c}_{2}^{i} , … , {c}_{k}^{i} ] .$$

C is all unread-aware contexts of the first node nᵢ. k denotes a quantity of possible execution paths from the main entry node to the first node nᵢ (the first node nᵢ and the critical node nᵢ are the same). For example, when the quantity of possible execution paths from the main entry node to the first node nᵢ is 1,

$${c}_{1}^{i}$$

denotes the thread-aware context from the main entry node to the first node nᵢ along this path.

The concurrency behavior node is a graph node in the CCPG denoting synchronization and thread management operations of the concurrent program. The critical node includes a concurrency behavior node. For example, as shown in FIG. 2, main (i.e., a main function) creates two threads t1 and t2. A write(x) statement is included in each of the two threads. When a critical node is write(x) in thread t1, a thread-aware context of write(x) in thread t1 is a path from the main function Thread main to the critical node write(x). The path includes an ancestor thread Thread main and a current thread t1. That is, the thread-aware context of write(x) in thread t1 is [fork(t1, call), acquire_lock(1)]. As another example, the thread-aware context of write(x) in thread t2 is [fork(t1, call), join(t1), fork(t2, call), acquire_lock(1)].

In some embodiments, the CONCODEQL traverses the initialized CCPG and constructs the thread-aware context. For example, for each critical node, the CONCODEQL traverses the initialized CCPG to obtain all paths from a main entry node to the critical node. The paths include all ancestor threads and a current thread of the critical node. Therefore, the CONCODEQL obtains the thread-aware context of the critical node.

In some embodiments, the CONCODEQL performs flow-sensitive happens-before analysis.

The flow-sensitive happens-before analysis refers to constructing a happens-before edge based on the thread-aware context. A main purpose of the flow-sensitive happens-before analysis is to infer an execution order between a first node and a second node.

The first node nᵢ and the second node nⱼ are two critical nodes currently being analyzed.

The execution order between the first node nᵢ and the second node nⱼ includes a scenario where the first node nᵢ and the second node nⱼ have a sequential execution order (i.e., the first node nᵢ and the second node nⱼ cannot execute concurrently). The execution order also includes a scenario where the first node nᵢ and the second node nⱼ do not have a sequential execution order (i.e., the first node nᵢ and the second node nⱼ may execute concurrently).

The happens-before edge is an edge in the CCPG that connects two critical nodes having a sequential execution order. If a happens-before edge exists between two critical nodes, the two critical nodes have a sequential execution order. That is, the two critical nodes cannot execute concurrently.

The fork set is a set of FORK nodes used to infer an execution order relationship between nodes in a concurrent program. More descriptions about the FORK node may be found in related descriptions later.

The fork set is defined as

$${fs}_{k}^{i} = \{ n ∈ {c}_{k}^{i} \vert λ ( n ) = Fork ( t ) ⋀ JOIN ( t ) ∉ {c}_{k}^{i} \} .$$

That is, the fork set

$${fs}_{k}^{i}$$

consists of one or more FORK nodes whose corresponding threads have not yet been joined within the thread-aware context. The corresponding thread refers to a thread corresponding to the critical node. FORK nodes whose corresponding threads have not yet been joined refer to critical nodes that have executed a thread creation operation (FORK) but has not executed an operation to wait for the thread to end (JOIN). n is a critical node in the thread-aware context (e.g., the first node nᵢ).

$${c}_{k}^{i}$$

is the thread-aware context corresponding to the current fork set. λ(n) is a node type determination function. A function of λ(n) is to return a type label of the critical node n. For example, λ(n)=Fork(t) indicates determining whether a type of the critical node n is a FORK node.

$$λ ( n ) = Fork ( t ) ⋀ JOIN ( t ) ∉ {c}_{k}^{i}$$

indicates determining whether the type of the critical node n is a FORK node whose corresponding thread has not yet been joined in the thread-aware context.

In some embodiments, for a critical node nᵢ, the CONCODEQL constructs a fork set

$${fs}_{k}^{i}$$

for each thread-aware context

$${c}_{k}^{i}$$

of the first node nᵢ. to analyze a happens-before relationship between the first node nᵢ and the second node nⱼ, the CONCODEQL checks whether the fork set of the first node nᵢ and the second node nⱼ have any overlap. An overlap between the fork sets of the first node nᵢ and the second node nⱼ indicates that the fork set of the first node nᵢ and the fork set of the second node nⱼ have at least one common element. An overlap between the fork sets of the first node nᵢ and the second node nⱼ indicates that the first node nᵢ and the second node nⱼ execute concurrently.

For example, the CONCODEQL uses the following formula to determine an hp relationship between the first node nᵢ and the second node nⱼ:

$$h p ( {n}_{i} , {n}_{j} ) = \{ \begin{matrix}0 , & {Λ}_{{k}_{1} ∈ [ 1 , {k}_{i} ] ; {k}_{2} ∈ [ 1 , {k}_{j} ]} {fs}_{{k}_{1}}^{i} ⋂ {fs}_{{k}_{2}}^{j} == ∅ \\ 1 , & otherwise\end{matrix}$$

In the formula, hp(nᵢ, nⱼ) is a concurrency relationship determination function. An input of the function is the first node nᵢ and the second node nⱼ. An output of the function is 0 or 1. 1 indicates that the first node nᵢ and the second node nⱼ may execute concurrently. The first node nᵢ and the second node nⱼ do not have a happens-before edge. 0 indicates that the first node nᵢ and the second node nⱼ cannot execute concurrently. The first node nᵢ and the second node nⱼ have a happens-before edge.

The happens-before relationship refers to a relationship of whether threads where two critical nodes are located have a sequential execution order. In some embodiments, if the threads where the two critical nodes are located have the happens-before relationship, a happens-before edge exists between the two critical nodes.

The hp relationship refers to a relationship of whether threads where two critical nodes are located may execute concurrently. In some embodiments, if the threads where the two critical nodes are located have the hp relationship, a happens-before edge does not exist between the two nodes.

Analyzing only the happens-before relationship is insufficient to determine whether the first node nᵢ and the second node nⱼ can execute concurrently. The first node nᵢ and the second node nⱼ may be protected by locks.

In some embodiments, the CONCODEQL performs an inter-procedural lock-set analysis.

For the first node nᵢ and the second node nⱼ, the inter-procedural lock-set analysis is an analysis process used to infer whether the first node nᵢ and the second node nⱼ are protected by a same lock.

A process of the inter-procedural lock-set analysis is as follows. For the first node nᵢ, the CONCODEQL first constructs a lock-set for each thread-aware context of the first node nᵢ. Then, the CONCODEQL determines whether the first node nᵢ and the second node nⱼ are protected by a same lock by checking whether the lock set of the first node nᵢ and the second node nⱼ have any overlap. In some embodiments, the CONCODEQL uses the following formula to determine a psl(protected by the same lock) relationship between the first node nᵢ and the second node nⱼ:

$$p s l ( {n}_{i} , {n}_{j} ) = \{ \begin{matrix}0 , & {Λ}_{{k}_{1} ∈ [ 1 , {k}_{i} ] ; {k}_{2} ∈ [ 1 , {k}_{j} ]} {ls}_{{k}_{1}}^{i} ⋂ {ls}_{{k}_{2}}^{j} == ∅ \\ 1 , & otherwise\end{matrix}$$

In the formula, psl(nᵢ, nⱼ) is a function for determining the psl relationship between the first node nᵢ and the second node nⱼ.

$${ls}_{{k}_{1}}^{i}$$

is the lock-set of the first node nᵢ.

$${ls}_{{k}_{2}}^{j}$$

is the lock-set of the second node

$${n}_{j} . {Λ}_{{k}_{1} ∈ [ 1 , {k}_{i} ] ; {k}_{2} ∈ [ 1 , {k}_{j} ]} {ls}_{{k}_{1}}^{i} ⋂ {ls}_{{k}_{2}}^{j} == ∅$$

indicates that all lock-sets corresponding to all thread-aware contexts of the first node nᵢ and all lock-sets corresponding to all thread-aware contexts of the second node nⱼ do not overlap each other. psl(nᵢ, nⱼ)=1 indicates that the psl relationship exists between the first node nᵢ and the second node nⱼ. psl (nᵢ, nⱼ)=0 indicates that the psl relationship does not exist between the first node nᵢ and the second node nⱼ. The psl relationship refers to a relationship where the first node nᵢ and the second node nⱼ are protected by a same lock.

For a thread-aware context

$${c}_{k}^{i}$$

of a path of a critical node n, a corresponding lock-set is defined as

$${ls}_{k}^{i} = \{ n ∈ {c}_{k}^{i} \vert λ ( n ) = acquire\_lock ( l ) ⋀ release\_lock ( l ) ∉ {c}_{k}^{i} \} .$$

The definition indicates that

$${ls}_{k}^{i}$$

consists of one or more lock-acquisition nodes whose corresponding locks have not yet been released within the thread-aware context. In the definition,

$$λ ( n ) = acquire\_lock ( l ) ⋀ release\_lock ( l ) ∉ {c}_{k}^{i}$$

indicates determining whether a node type of node n is lock-acquisition node whose corresponding locks have not yet been released within the thread-aware context. The lock-acquisition node whose corresponding lock has not yet been released refers to a critical node that has executed a lock acquisition operation but has not executed a lock release operation on a specific execution path.

When psl(nᵢ, nⱼ)=1, i.e., when the psl relationship exists between the first node nᵢ and the second node nⱼ, the CONCODEQL determines that the first node nᵢ and the second node n are protected by a same lock. When psl(nᵢ, nⱼ)=0, i.e., when the psl relationship does not exist between the first node nᵢ and the second node nⱼ, the CONCODEQL determines that the first node nᵢ and the second node nⱼ are not protected by a same lock.

The enhanced concurrent pointer analysis is a key aspect of static analysis. Existing manners aim to address unique challenges posed by concurrent environments. In particular, a flow-sensitive multi-threaded pointer analysis way is proposed based on a sparse value flow (SVF) framework. Although the existing manners have made significant progress, they have some limitations in handling global variables and structs.

The enhanced concurrent pointer analysis is an analysis process used to determine whether two or more pointers used by critical nodes may point to a same memory address. A pointer is a manner in which a critical node accesses data (e.g., a global variable or a struct).

In some embodiments, the enhanced concurrent pointer analysis includes global variable analysis and struct analysis.

The global variable analysis is an analysis process used to determine whether two or more global variable pointers used by critical nodes may point to a same memory address. The global variable pointer is a manner in which a critical node accesses a global variable.

The global variables are an important component of shared memory in concurrent programs. However, when using advanced pointer analysis tools such as SVF-Tool to analyze more complex programs, errors often occur in analyzing global variables. This problem may stem from an inherent insensitivity of compiler infrastructure and intermediate denotations (e.g., LLVM) to global variables. To address this problem, the CONCODEQL performs the global variable analysis.

In some embodiments, the global variable analysis represents a precise analysis of global variables, designed by analyzing the CCPG and the VFG.

In some embodiments, the global variable analysis includes: identifying all global variable declarations by traversing the CCPG, thereby obtaining a global variable set, reconstructing connections between global variables and local variables, and determining one or more global variable aliases through flow-sensitive pointer analysis.

The global variable declaration refers to a statement used to declare a global variable.

The global variable set is a set including all global variables declared by all global variable declarations in the CCPG.

In some embodiments, the CONCODEQL, according to the VFG, starts from a global variable node and traces back along value flow edges in the VFG to find all local variables directly pointing to an address of the global variable, thereby establishing connections between the global variable and the local variables. The value flow edge is an edge in the VFG that characterizes a direction of value flow transfer in a program.

The global variable alias refers to a plurality of pointers pointing to a same global variable.

The struct analysis is an analysis process used to determine whether two or more struct pointers used by a critical node may point to a same memory address. The struct pointer is a manner in which the critical node accesses a struct.

The struct is a composite data type used to combine a plurality of attributes of different types into a logical unit.

Existing manners can accurately analyze struct pointers, but it is difficult to determine which attribute of a struct a struct pointer is accessing. Using a code property graph (CPG) can effectively solve this problem. In the struct analysis, for an access node of a struct s, the CONCODEQL uses a regular expression-based determination to simply obtain a specific attribute accessed by the access node through the CPG, such as s→a or s.b, to distinguish a pointer pointing to s and a pointer pointing to s→a. The CONCODEQL analyzes the CCPG and the VFG, and adjusts a representation of the struct in the flow-sensitive pointer analysis to the specific attribute. The access node of the struct refers to a critical node that accesses the struct.

The regular expression judgment is a process of extracting a specific attribute of the access node of the struct from the critical node in the CPG.

In some embodiments, when an operation accessing a struct exists in the CPG (e.g., s→data or s.data), the regular expression judgment separates a variable name of the struct (e.g., s) and a specific attribute (e.g., data) from source code corresponding to the access node of the struct.

The specific attribute accessed by the access node refers to an attribute operated on by the access node.

A denotation of the struct refers to a form of the struct, and the denotation of the struct includes a specific attribute of the struct.

In some embodiments, the CONCODEQL assigns the specific attribute accessed by the access node to the specific attribute of the struct.

In some embodiments, the CONCODEQL performs thread-aware, flow-sensitive analysis.

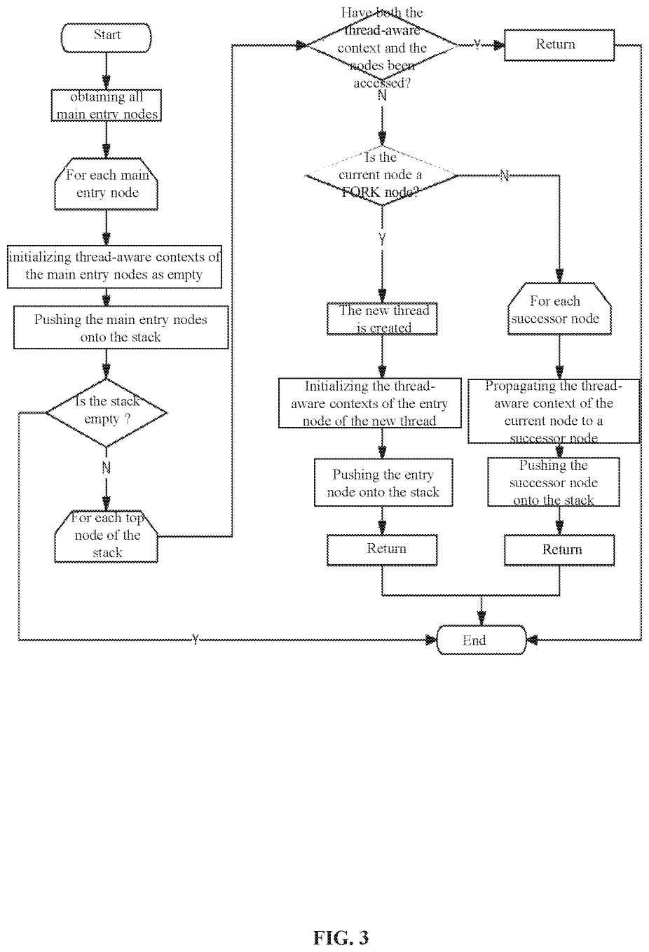

FIG. 3 is a flowchart of a process for constructing a thread-aware context according to some embodiments of the present disclosure. As shown in FIG. 3, the CONCODEQL first obtains all main entry nodes from the CCPG and initializes thread-aware contexts of the main entry nodes as empty. Nodes with different thread-aware contexts may be visited a plurality of times. During a main loop, if a current node with a current thread-aware context is accessed, the CONCODEQL directly terminates the loop; otherwise, the CONCODEQL traverses the CCPG along a thread-lifecycle edge and control-flow edge. If the current node n is a FORK node that creates a new thread, a thread-aware context of an entry node n′ of the new thread is initialized to each thread-aware context previously added to the current node n, and a new thread t_{new} is created. If the current node n is not a FORK node, the CONCODEQL traverses proceeds along the control-flow edge and the thread-aware context of the current node n is propagated to a successor node. Afterwards, the thread-aware context for each critical node is utilized for the flow-sensitive happens-before analysis and the inter-procedural lock-set analysis. Then, based on the thread-aware context of each critical node, the CONCODEQL traverses any pair of threads (e.g., t1 and t2 in FIG. 2) and checks whether memory access nodes of the pair of threads can execute concurrently.

Specifically, if the first node nᵢ and the second node nⱼ simultaneously satisfy that: 1) the first node nᵢ and the second node nⱼ access a same memory location; 2) the first node nᵢ and the second node nⱼ execute concurrently; 3) the first node nᵢ and the second node nⱼ are not protected by a common lock, the CONCODEQL adding the HP edge between the first node nᵢ and the second node nⱼ; wherein an updated CCP is generated when the loop terminates.

Finally, an updated CCPG is generated. Each thread-aware context previously added to the current node n refers to each thread-aware context that has been accumulated to the current node n during the traversal process. A successor node refers to a next critical node to be traversed after traversing the current node n in the traversal process. The HP edge exists between two critical nodes that have an hp relationship.

In some embodiments, the CONCODEQL determines whether a first node nᵢ and a second node nⱼ may execute concurrently through flow-sensitive happens-before analysis, determines whether the first node nᵢ and the second node nⱼ are protected by a same lock through inter-procedural lock-set analysis, and determines whether the first node nᵢ and the second node nⱼ access a same memory location through enhanced concurrent pointer analysis. More descriptions about the hp relationship may be found in related descriptions above.

More descriptions about a memory access node, a thread-lifecycle edge, and a control-flow edge may be found in related descriptions below.

In S3, a concurrent vulnerability is detected based on a domain-specific language (DSL).

The concurrent vulnerabilities are roughly classified into data races, deadlocks, atomicity violations, and order violations. Although there are many tools for detecting data races and deadlocks, due to complex relationships and rules between interfaces (APIs, Application Programming Interface), there are fewer tools for solving atomicity violations and order violations, and solving the above problems requires a large amount of pattern mining or document understanding. The DSL can effectively solve these challenges, enabling users to flexibly define atomic operations and relationships between interfaces, thereby facilitating effective detection of atomicity violations and order violations.

In some embodiments, the CONCODEQL designs one or more query interfaces of the DSL for different types of concurrent vulnerabilities, performs queries on the CCPG to conduct concurrent vulnerability detection, and outputs detected concurrency vulnerabilities as a vulnerability report.

The concurrent vulnerability refers to a concurrency error existing in the source code.

Types of concurrent vulnerabilities are roughly classified into data races, deadlocks, atomicity violations, and order violations. There are many tools for detecting data races and deadlocks. Due to complex relationships and rules between query interfaces (APIs, Application Programming Interface), there are fewer tools for solving atomicity violations and order violations. Solving the problems of atomicity violations and order violations requires a large amount of pattern mining or document understanding. The DSL effectively solves these challenges, enabling users to flexibly define atomic operations and relationships between APIs, thereby facilitating effective detection of atomicity violations and order violations.

The DSL is a language that provides a formal description for queries on the CCPG, aiming to cover all types of concurrent vulnerabilities.

The domain-specific language (DSL) query interface refers to a query interface for querying concurrent vulnerabilities.

The concurrent vulnerability detection refers to a detection process for detecting concurrent vulnerabilities.

The vulnerability report refers to data output after the concurrent vulnerability detection for reporting concurrent vulnerabilities.

In some embodiments, the vulnerability report includes two critical nodes where a concurrent vulnerability exists.

In some embodiments of the present disclosure, the CONCODEQL significantly enhances an analysis capability for global variables through global variable analysis by using information provided by a code concurrent property graph (CCPG).

In some embodiments of the present disclosure, the CONCODEQL can significantly improve the accuracy of analysis by adjusting a denotation of the struct to specific attributes through struct analysis.

In some embodiments of the present disclosure, by introducing the CCPG, various relationships and features in source code can be comprehensively expressed, overcoming a deficiency that existing static code detection manners based on structured denotations have difficulty identifying complex concurrent vulnerabilities. By using the DSL, detection for different types of concurrent vulnerabilities is supported, greatly improving the extensibility of the way to adapt to a wider range of application scenarios. Finally, by combining the CCPG, the DSL can comprehensively analyze syntactic relationships, memory access patterns, and concurrency mechanisms in the source code, thereby effectively reducing a false positive rate and a false negative rate of traditional data race detection manners and enhancing a detection capability for complex concurrency problems. Therefore, a technical foundation is provided for a more universal and mature concurrent vulnerability detection tool, significantly improving a security and a reliability of software.

In some embodiments, the vulnerability detection tool CONCODEQL determines one or more risk nodes through a risk screening algorithm based on the source code and the critical nodes. The CONCODEQL starting from a risk node, traverses the CCPG backward along the control-flow edge and a data dependency edge. In response to reaching the main entry node, the CONCODEQL constructs a risk subgraph corresponding to the risk node; and designates one or more risk subgraphs as the CCPG and performs the S2.

The risk node refers to a critical node where a concurrent vulnerability may exist.

In some embodiments, the risk node refers to a node pair that simultaneously satisfies a memory condition, a concurrency condition, and a lock condition. The memory condition refers to a memory conflict existing in the node pair. The concurrency condition refers to the node pair being executable concurrently. The lock condition refers to the node pair being protected by the same lock. The node pair is constituted by two critical nodes.

The risk screening algorithm refers to an algorithm for screening risk nodes from critical nodes by performing preliminary screening on the source code.

In some embodiments, the risk screening includes a memory preliminary screening algorithm, a concurrency preliminary screening algorithm, and a lock preliminary screening algorithm.

The memory preliminary screening algorithm refers to an algorithm for roughly screening node pairs where a memory conflict exists. The memory preliminary screening algorithm is a flow-insensitive algorithm, such as a Steensgaard algorithm.

In some embodiments, for any node pair constituted by two critical nodes, the CONCODEQL determines whether the node pair satisfies the memory condition through the memory preliminary screening algorithm.

The concurrency preliminary screening algorithm refers to an algorithm for roughly screening node pairs that are executable concurrently. The concurrency preliminary screening algorithm is a flow-insensitive and context-insensitive pointer analysis. For example, a Steensgaard algorithm.

In some embodiments, for any node pair constituted by two critical nodes, the CONCODEQL determines whether the node pair satisfies the concurrency condition through the concurrency preliminary screening algorithm.

The lock preliminary screening algorithm refers to an algorithm for roughly screening node pairs protected by the same lock.

In some embodiments, for any node pair constituted by two critical nodes, CONCODEQL first identifies protection locks respectively corresponding to the two critical nodes in the node pair. If the protection locks of the two critical nodes are the same lock, CONCODEQL determines that the node pair satisfies the lock condition. The protection lock corresponding to the critical node refers to a lock that protects the critical node in the current thread where the critical node is located. For example, if the critical node is first locked by a lock L through lock(L) and then released through release (L) in the current thread where the critical node is located, the protection lock corresponding to the critical node is the lock L.

In some embodiments, the lock preliminary screening algorithm does not focus on protection locks of a critical node across threads. That is, if a critical node a is first locked by a lock L through lock(L) in a thread t1 and then released by the lock L through release (L) in a thread t2, the lock L is not identified as a protection lock of the critical node a by the lock preliminary screening algorithm.

The risk subgraph refers to a subgraph constituted by content related to a risk node in the CCPG.

In some embodiments, the CONCODEQL traverses the CCPG backward along the control-flow edges and the data dependency edges of the CCPG starting from the risk node until reaching the main entry node. The CONCODEQL uses a portion of the CCPG traversed from the risk node to the main entry node as the risk subgraph.

In some embodiments, the CONCODEQL designates one or more risk subgraphs corresponding to each risk node as the CCPG and performs the S2.

In some embodiments of the present disclosure, the CONCODEQL can effectively narrow a processing scope and accelerate a processing procedure by screening the critical nodes through the risk screening algorithm and reducing the CCPG based on the obtained risk node.

In some embodiments, when the count of risk nodes exceeds a preset threshold, the CONCODEQL performs a review procedure for each risk node.

The review procedure refers to a process for further screening risk nodes to reduce the quantity of risk nodes.

In some embodiments, the review procedure includes: for each risk node, performing a backtracking operation to obtain a memory node corresponding to the risk node; in response to that one or more memory nodes satisfy a first preset condition, labeling the risk node; starting from an unlabeled risk node, traversing the CCPG backward along the control-flow edge and the data dependency edge, in response to reaching the main entry node, constructing the risk subgraph corresponding to the risk node; and designating the one or more risk subgraphs as the CCPG and proceeding to perform the S2. The preset quantity is preset based on experience.

The backtracking operation refers to a process for finding a memory node corresponding to a pointer.

In some embodiments, for each risk node, the CONCODEQL performs the backtracking operation to obtain the memory node corresponding to the risk node.

In some embodiments, the backtracking operation is a Def-Use chain technique.

The first preset condition refers to a condition for determining whether two or more risk nodes point to the same memory access node. The first preset condition is that memory access nodes of two or more risk nodes are the same.

In some embodiments, after obtaining memory access nodes corresponding to a plurality of risk nodes, in response to memory access nodes of two or more risk nodes being the same, the CONCODEQL marks the two or more risk nodes with the same memory access node.

In some embodiments of the present disclosure, the CONCODEQL can effectively narrow the processing scope and accelerate the processing procedure by further screening the risk nodes through the review procedure.

In some embodiments, an alert level is determined based on the vulnerability report; in response to that the alert level exceeds an alert threshold, an alarm signal transmission frequency is determined according to the alert level, and the alarm signal transmission frequency is transmitted to a monitoring terminal, to control a communication interface of the monitoring terminal to send warning information to an operation and maintenance terminal at the alarm signal transmission frequency, and/or to activate warning flashing; in response to that the alert level does not exceed the alert threshold, the source code is deployed to a target server.

The alert level refers to a parameter for measuring a severity of a concurrent vulnerability in the vulnerability report.

In some embodiments, the CONCODEQL determines the alert level by querying a first preset table based on a type of concurrent vulnerability in the vulnerability report. The first preset table records a correspondence between a type of concurrent vulnerability in the vulnerability report and an alert level. The first preset table is preset based on manual experience.

The alarm signal transmission frequency refers to a parameter of a time interval for controlling transmission of warning information, such as once per second or once per minute.

In some embodiments, the CONCODEQL determines the alarm signal transmission frequency by querying a second preset table according to the alert level. The second preset table records a correspondence relationship between the alert level and the alarm signal transmission frequency. A higher alert level corresponds to a shorter transmission interval, i.e., a higher alarm signal transmission frequency. The second preset table is preset based on manual experience.

The monitoring terminal refers to a device or a program for monitoring operations of the CONCODEQL and obtaining a vulnerability report. For example, the monitoring terminal is a thread for monitoring.

The operation and maintenance terminal is a device for displaying operation and maintenance during operation and maintenance of the source code, such as a monitoring dashboard or a mobile terminal of a security administrator.

In some embodiments, the CONCODEQL controls a communication interface of the monitoring terminal to send warning information to the operation and maintenance terminal according to the alarm signal transmission frequency. The warning information is preset alarm content. For example, a monitoring program sends the vulnerability report to the monitoring dashboard according to the alarm signal transmission frequency.

In some embodiments, the CONCODEQL controls the communication interface of the monitoring terminal to perform warning flashing to the operation and maintenance terminal according to the alarm signal transmission frequency. The warning flashing is a manner in which the operation and maintenance terminal alarms by flashing. For example, the monitoring program controls the monitoring dashboard to flash according to the alarm signal transmission frequency.

The target server refers to a physical or virtual server for running the source code.

In some embodiments, in response to the alert level being less than or equal to an alert threshold, the CONCODEQL deploys the source code to the target server.

In some embodiments of the present disclosure, intelligent operation and maintenance response are achieved through the alert level. When the alert level is relatively high, an alarm frequency is adaptively adjusted to remind operation and maintenance personnel, ensuring that risks are handled in a timely manner; when the alert level is relatively low, deployment is automatically allowed, thereby reducing the operation and maintenance burden while ensuring release security.

In some embodiments, after deploying the source code to the target server, the CONCODEQL periodically performs following operation at a preset interval: the CONCODEQL extracts the deployed source code from the target server. The CONCODEQL determines the vulnerability report for that deployed source code based on the deployed source code. In response to that the vulnerability report satisfies a second preset condition, the CONCODEQL determines a target blocking port of the target server where the deployed source code is located based on the vulnerability report, controls a switch to block the target blocking port, redirects traffic intended for the target blocking port to a cleaning card, uses the cleaning card to filter out a data packet that matches vulnerability-triggering characteristics, and forwards the cleaned traffic back to the target server.

The preset period is a time interval for periodic detection of the deployed source code performed by the CONCODEQL.

In some embodiments, the preset period is preset according to manual experience.

In some embodiments, the CONCODEQL executes S1-S3 according to the deployed source code to obtain the vulnerability report of the deployed source code.

The second preset condition is a condition for identifying whether program code is in an extremely dangerous concurrent state. The second preset condition is that a vulnerability risk is greater than a preset risk threshold. The vulnerability risk is a parameter characterizing a danger degree of a concurrent vulnerability. In some embodiments, the CONCODEQL determines the vulnerability risk by querying a third preset table according to a vulnerability type. The third preset table records a correspondence relationship between the vulnerability type and the vulnerability risk. The third preset table is preset according to manual experience. The preset risk threshold is preset according to manual experience.

The target blocking port is a specific network port count that needs to be subjected to network access blocking.

In some embodiments, the CONCODEQL obtains a vulnerability location (e.g., a code line where a critical node is located) from the vulnerability report; determines a functional module (e.g., a login module, a payment module) corresponding to the concurrent vulnerability according to the vulnerability location; and determines the target blocking port (e.g., TCP 8080) by querying a fourth preset table according to the functional module corresponding to the concurrent vulnerability.

For example, the CONCODEQL determines a content module corresponding to a thread where the critical node is located according to the code line where the critical node is located. The fourth preset table records a correspondence relationship between the functional module and the target blocking port. The CONCODEQL extracts the correspondence relationship between the functional module and the target blocking port based on a deployment record of code in a code repository, constructs the fourth preset table, regularly updates the deployment record of the deployed source code, and extracts the correspondence relationship between the functional module and the target blocking port to update the fourth preset table.

The switch is an execution terminal for executing a port blocking instruction.

The cleaning card is a hardware security device dedicated to fine-grained traffic cleaning. For example, the cleaning card is an FPGA chip or an ASIC chip.

The port blocking refers to an operation of cutting off an attack path from a physical link level by controlling network infrastructure.

In some embodiments, the CONCODEQL controls the switch to perform the port blocking on the target blocking port. For example, the CONCODEQL sends an Access Control List (ACL) instruction to a switch connected to a server where the source code is located (e.g., the target server where the source code is deployed), to physically block external traffic from entering the target blocking port of the server (e.g., blocking port 8080).

The cleaned traffic refers to traffic data obtained after performing traffic cleaning on the traffic directed to the target blocking port. The traffic cleaning refers to a defense means for filtering traffic without completely interrupting a service. In some embodiments, the cleaned traffic refers to traffic composed of remaining data packets after filtering out data packets conforming to the vulnerability trigger feature from the traffic directed to the target blocking port. The vulnerability trigger feature refers to a specific data pattern capable of inducing abnormal code execution. For example, the vulnerability trigger feature is a specific character sequence for an SQL injection vulnerability (e.g., OR 1=1), an overlength string pattern for a buffer overflow vulnerability, a specific malicious hexadecimal instruction fragment for a remote code execution vulnerability, or the like. The vulnerability trigger feature is extracted from the vulnerability report.

In some embodiments, the CONCODEQL diverts the traffic directed to the target blocking port to the cleaning card; filters out, by using the cleaning card through the traffic cleaning, data packets conforming to the vulnerability trigger feature; and forwards the cleaned traffic after the traffic cleaning back to the target server.

In some embodiments of the present disclosure, the risk control is implemented in a pre-deployment stage, and real-time security protection is performed after the source code is deployed to the target server, achieving a full-process closed loop from vulnerability detection to automatic response at a network hardware level; the active defense capability of the system is significantly improved through the port blocking and the traffic cleaning.

In some embodiments, the CONCODEQL generates the CPG and the VFG from the source code, identifies concurrency-related interfaces from the CPG, and defines the CCPG for the concurrent program by integrating information derived from the VFG.

The concurrency-related interface is an interface for creating and managing threads and synchronization mechanisms. In some embodiments, the CONCODEQL identifies concurrency-related interfaces from a code property graph (CPG) according to preset keywords (e.g., fork, alloc, or the like). The preset keywords are preset based on manual experience.

The information obtained from a value flow graph (VFG) refers to information describing a flow trajectory of data in a program.

The code concurrent property graph (CCPG) includes nodes and edges.

The nodes of the CCPG include memory access nodes, concurrency behavior nodes, and other nodes.

The memory access nodes are configured to represent accesses to memory in the source code. As shown in FIG. 2, write(x) is a memory access node.

The memory access node may be used by a concurrency mechanism for operations such as thread synchronization, communication, and scheduling. The memory access node corresponds to four behaviors in the source code: address allocation (ALLOC), address release (FREE), variable reading (READ), and variable writing (WRITE). As shown in FIG. 2, write(x) corresponds to variable writing (WRITE) in the source code.

The concurrency behavior node is one of the most important categories of nodes in the CCPG and is also one of the main differences from a conventional CPG. The concurrency behavior node corresponds to a concurrency-related interface in the source code.

In some embodiments, the concurrency behavior node includes a thread organization node and a synchronization logic node.

The thread organization node is a node type configured to describe a thread-lifecycle management operation. A thread organization node corresponds to the concurrency-related interface in the source code for creating a program, terminating a program, or the like.

In some embodiments, the thread organization node includes the FORK node, the JOIN nodes, the DETACH nodes, and the EXIT nodes.

The FORK node denotes an operation of creating a new thread. The FORK node corresponds to a concurrency-related interface for creating a program in the source code. For example, fork(t2, call) in FIG. 2 is regarded as a FORK node.

The JOIN node denotes an operation of waiting for a specific thread to end. The JOIN node corresponds to a concurrency-related interface for synchronizing threads in the source code. For example, join(t2) in FIG. 2 is regarded as a JOIN node.

The DETACH node denotes an operation of setting a thread to a detached state. The DETACH node corresponds to a concurrency-related interface for setting a thread separation attribute in the source code. For example, detach (t1) is regarded as a DETACH node.

The EXIT node denotes an operation point where a thread execution ends. The EXIT node corresponds to a concurrency-related interface for terminating a program in the source code. For example, an explicit return statement of a thread function, exit (t1), or the like, is regarded as an EXIT node.

The synchronization logic node is a node category configured to describe and control a synchronization operation for accessing a shared resource.

Ther synchronization logic node includes a lock-acquisition node ACQUIRE and a lock-release node RELEASE.

The lock-acquisition node ACQUIRE denotes a node that successfully acquires a lock. As shown in FIG. 2, acquire_lock(1) is a lock-acquisition node ACQUIRE.

The lock-release node RELEASE denotes an operation of releasing a held lock. As shown in FIG. 2, release_lock(1) is a lock-release node RELEASE.

The other nodes are nodes denoting basic operation logic of a program, such as an assignment node, a branch node, a call node, a function node, and a return node.

The edges of the CCPG include CPG edges and concurrency relation edges.

The CPG edge describes a syntactic structure, a control flow, a data dependency relationship, or the like in the source code.

In some embodiments, the CPG edge includes an abstract syntax tree edge, a control-flow edge, and a dependency edge.

The abstract syntax tree edge is an edge denoting a syntactic nesting structure of code, such as an edge connecting a function declaration node and a parameter node of the function declaration node, an edge connecting a conditional statement node and a branch statement block of the conditional statement node, or the like.

The control-flow edge is an edge denoting a possible execution order of a program, such as an edge from a function entry to a first statement, or an edge from a judgment node of a conditional statement to two branches of the conditional statement.

The data dependency edge is an edge denoting a value transfer relationship between statements or variables, such as an edge from a variable assignment statement node to an expression node reading a value of the variable.

The concurrency relation edge is an edge expressing an interaction and a timing relationship between threads in a concurrent program.

In some embodiments, a concurrency relation edge includes a thread-lifecycle edge and an May-Happens-Parallel edge.

The thread-lifecycle edge is an edge describing a creation and a joining relationship of the thread. The thread-lifecycle edge is crucial for establishing an execution order in concurrent operations.

In some embodiments, the thread-lifecycle edge includes an edge from a FORK node to a corresponding thread entry, and an edge from a thread exit to a JOIN node.

The edge indicating possible concurrent execution connects critical nodes from different threads that may execute concurrently. In some embodiments, the May-Happens-Parallel edge only connects critical nodes accessing a same memory location.

In some embodiments of the present disclosure, by clearly defining nodes and edges, the CCPG can accurately model concurrency semantics such as thread creation and synchronization. The CCPG provides a unified and rich data foundation for subsequent development of domain-specific language (DSL) queries targeting different types of concurrent vulnerabilities (e.g., data races, deadlocks). The CCPG greatly enhances an adaptation capability of a detection tool, thereby effectively reducing false positive and false negative rates and achieving precise identification of complex concurrency problems.

In some embodiments, the domain-specific language (DSL) provides a formal description for queries on a code concurrent property graph (CCPG), aiming to cover all types of concurrent vulnerabilities.

The DSL is defined by a grammar L={V_{T}, V_{N}, P, S}, wherein V_{T} is a set of terminal symbols, V_{N} is a set of non-terminal symbols, P is a production rule set that serves as a primary structural unit of the grammar, the production rule set includes production rules, each production rule is expressed as α::=β, wherein a denotes a sentence component (e.g., “a noun phrase”), and β describes a rule for forming (e.g., “adjective+noun”). The production rules describe a process for combining elements from the terminal symbol set and non-terminal symbol set into strings, S is a start symbol.

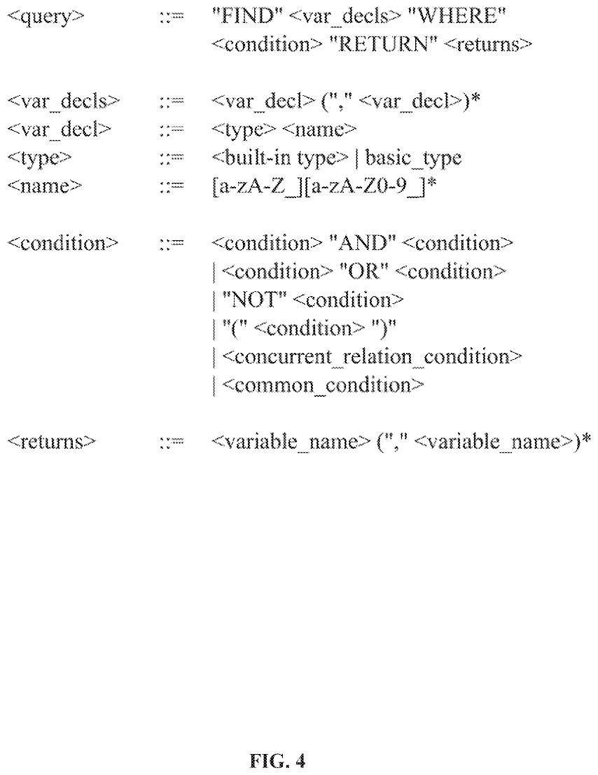

FIG. 4 is a schematic diagram of a main framework of a domain-specific language (DSL) according to some embodiments of the present disclosure.

An architecture of the DSL is shown in FIG. 4. The DSL is designed by utilizing and extending query statements used in a CodeQL domain-specific language; in the domain-specific language, <query> represents the start symbol in the definition and serves as an entry point of the domain-specific language; <var_decls> denotes a variable declaration, including a basic variable type and a built-in type <built-in type>; <condition> defines constraints within a query; <return> specifies a value returned by the query.

A domain specificity of the domain-specific language in a concurrency field is reflected in a structure <built-in type> and <concurrent_relation_condition>; <concurrent_relation_condition> includes <access_condition>, <hb_relationship>, and <lock condition>, configured to process the enhanced concurrent pointer analysis, the flow-sensitive happens-before analysis, and the inter-procedural lock-set analysis, respectively. Specifically, the inter-procedural lock-set analysis includes an IS_PROTECTED_BY manner and an IS_AUTOMATICALLY_PROTECTED_BY manner, the IS_PROTECTED_BY manner determines whether two variables are protected by a same lock, and the IS_AUTOMATICALLY_PROTECTED_BY manner checks whether operations are within a same critical section to ensure atomicity.

In some embodiments, the type of concurrent vulnerability includes a data race. CONCODEQL performs a query for data race detection by using the DSL.

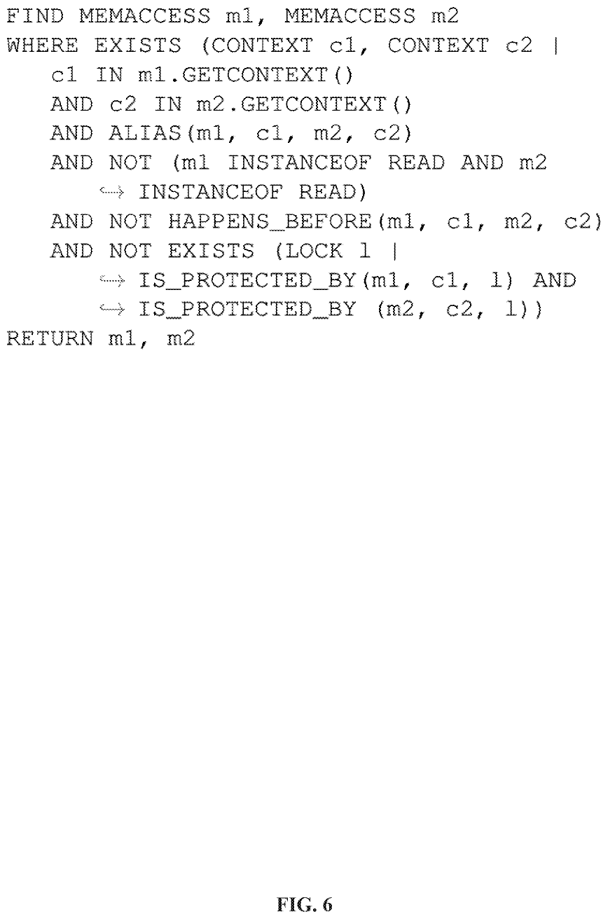

FIG. 6 is a schematic diagram of a screenshot of an examplary query for data race detection according to some embodiments of the present disclosure.

The query statement for data race detection is shown in FIG. 6, MEM_ACCESS, CONTEXT, and LOCK are variables of the built-in variable type, MEM_ACCESS corresponds to a memory access node, and CONTEXT and LOCK respectively denote results of constructing a thread-aware context and performing the inter-procedural lock-set analysis. An ALIAS operation is used to determine whether two memory access nodes are pointer aliases in the thread-aware context. In addition, to be consistent with a definition of a data race, an additional condition is that the two memory access nodes cannot both be of a READ type. Statements using NOT HAPPENS_BEFORE and IS_PROTECTED_BY ensure that the two memory access nodes may execute concurrently, i.e., the two memory access nodes are not effectively protected by locks.

In some embodiments, the syntax L enhances the capability of detecting a large count of concurrent vulnerabilities.

What is claimed is:

1. A concurrency vulnerability detection method based on a code concurrency property graph (CCPG), wherein the method adopts a vulnerability detection tool CONCODEQL, and comprises:
S1, initializing a code property graph (CPG) and identifying one or more critical nodes based on a source code to be tested, including: initializing the CCPG and identifying one or more critical nodes within a concurrent program of the CCPG based on the source code to be tested, the CPG, and a value flow graph (VFG);
S2, constructing one or more concurrency relationships by traversing the CCPG, including: traversing the initialized CCPG, constructing a thread-aware context, and sequentially performing flow-sensitive happens-before analysis, inter-procedural lock-set analysis, and enhanced concurrent pointer analysis based on the thread-aware context, and constructing the one or more concurrency relationships for the one or more critical nodes in the CCPG;
performing thread-aware analysis and thread-aware, flow-sensitive analysis;
wherein the performing the thread-aware analysis includes:
defining the thread-aware context for a critical node as one or more paths from a main entry node to the critical node that collectively encompass all ancestor threads and a current thread;
denoting a thread-aware context along a specific path as c=[n₁, n₂, . . . , nₘ], wherein each element denotes a concurrency behavior node, all thread-aware contexts of a critical node nᵢ are denoted as a two-dimensional matrix
$$C = [ {c}_{1}^{i} , {c}_{2}^{i} , … , {c}_{k}^{i} ] ,$$
and k denotes a count of feasible execution paths from the main entry node to the critical node;
the flow-sensitive happens-before analysis includes: constructing one or more happens-before edges based on the thread-aware context to determine an execution order between a first node nᵢ and a second node nⱼ; for the first node nᵢ, constructing a fork set for each thread-aware context of the first node nᵢ; defining the fork set as
$${fs}_{k}^{i} = \{ n ∈ {c}_{k}^{i} \vert λ ( n ) = Fork ( t ) ⋀ JOIN ( t ) ∉ {c}_{k}^{i} \} ,$$
wherein the fork set consists of one or more FORK nodes whose corresponding threads have not yet been joined within the thread-aware context, the CONCODEQL checks whether fork sets of the first node nᵢ and the second node n have any overlap, an overlap between the fork sets of the first node nᵢ and the second node nⱼ indicates that the first node nᵢ and the second node nⱼ execute concurrently, and a hp relationship between the first node nᵢ and the second node nⱼ is determined using following formula:
$$h p ( {n}_{i} , {n}_{j} ) = \{ \begin{matrix}0 , & {Λ}_{{k}_{1} ∈ [ 1 , {k}_{i} ] ; {k}_{2} ∈ [ 1 , {k}_{j} ]} {fs}_{{k}_{1}}^{i} ⋂ {fs}_{{k}_{2}}^{j} == ∅ \\ 1 , & otherwise\end{matrix}$$
performing the inter-procedural lock-set analysis includes: analyzing the happens-before relationship is insufficient to determine whether the first node nᵢ and the second node nⱼ are capable of concurrent execution, because the first node nᵢ and the second node nⱼ are capable of being protected by locks; for the first node nᵢ and the second node nⱼ, performing the inter-procedural lock-set analysis is performed to determine whether the first node nᵢ and the second node nⱼ are protected by a same lock; for the first node nᵢ, the CONCODEQL constructs a lock set for each thread-aware context of the first node nᵢ; wherein the lock set
$${ls}_{k}^{i} = \{ n ∈ {c}_{k}^{i} \vert λ ( n ) = acquire\_lock ( l ) ⋀ release\_lock ( l ) ∉ {c}_{k}^{i} \} .$$
the lock set consists of one or more lock-acquisition nodes whose corresponding locks have not yet been released within the thread-aware context; the CONCODEQL determines whether the first node nᵢ and the second node nⱼ are protected by a same lock by checking whether lock sets of the first node nᵢ and the second node nⱼ have any overlap; a psl relationship between the first node nᵢ and the second node nⱼ is determined using following formula:
$$psl ( {n}_{i} , {n}_{j} ) = \{ \begin{matrix}0 , & {Λ}_{{k}_{1} ∈ [ 1 , {k}_{i} ] ; {k}_{2} ∈ [ 1 , {k}_{j} ]} {ls}_{{k}_{1}}^{i} ⋂ {ls}_{{k}_{2}}^{j} == ∅ \\ 1 , & otherwise\end{matrix}$$
performing the enhanced concurrent pointer analysis, wherein the enhanced concurrent pointer analysis includes global variable analysis and struct analysis;
the global variable analysis denotes a precise analysis of global variables, designed by analyzing the CCPG and the VFG, including: identifying all global variable declarations by traversing the CCPG, thereby obtaining a global variable set; reconstructing connections between global variables and local variables, and determining one or more global variable aliases through flow-sensitive pointer analysis;
the struct analysis includes: for an access node of a struct, simply obtaining a specific attribute accessed by the access node through the CPG using a regular expression-based determination, wherein the CONCODEQL analyzes the CCPG and the VFG, and adjusting a denotation of the struct in the flow-sensitive pointer analysis to the specific attribute;
the thread-aware, flow-sensitive analysis includes:
traversing the CCPG, and constructing the thread-aware context for each critical node;
wherein the CONCODEQL obtains the all main entry nodes from the CCPG and initializes the thread-aware contexts of the main entry nodes as empty; during a main loop, if a current node with a current thread-aware context is accessed, the CONCODEQL directly terminates the loop;
otherwise, the CONCODEQL traverses the CCPG along a thread-lifecycle edge and control-flow edge, if a current node n is a FORK node that creates a new thread, a thread-aware context of an entry node n′ of the new thread is initialized to each thread-aware context previously added to the current node n, and the new thread is created; if the current node n is not a FORK node, the CONCODEQL traversal proceeds along the control-flow edge, and the thread-aware context of the current node n is propagated to a successor node; the thread-aware context for each critical node is utilized for the flow-sensitive happens-before analysis and the inter-procedural lock-set analysis;
the CONCODEQL traversing any pair of threads and checks whether memory access nodes of the thread pair execute concurrently based on the thread-aware context of each critical node, including: if the first node nᵢ and the second node nⱼ simultaneously satisfy that: 1) the first node nᵢ and the second node nⱼ access a same memory location; 2) the first node nᵢ and the second node nⱼ execute concurrently; 3) the first node nᵢ and the second node n are not protected by a same lock, the CONCODEQL adding an HP edge between the first node nᵢ and the second node nⱼ; wherein an updated CCP is generated when the loop terminates;
S3, detecting a concurrency vulnerability based on a domain-specific language, including: designing one or more query interfaces of the domain-specific language for different types of concurrency vulnerabilities, performing queries on the CCPG to conduct concurrency vulnerability detection, and outputting detected concurrency vulnerabilities as a vulnerability report.

2. The concurrency vulnerability detection method based on a code concurrency property graph (CCPG) of claim 1, wherein the S1 includes:
the CONCODEQL generating the CPG and the VFG from the source code, identifying concurrency-related interfaces from the CPG, and defining the CCPG for the concurrent program by integrating information derived from the VFG;
wherein nodes in the CCPG include memory access nodes, concurrency behavior nodes, and other nodes;
the memory access nodes are configured to denote accesses to memory in the source code;
the concurrency behavior nodes correspond to concurrency-related interfaces in the source code and the concurrency behavior nodes include thread organization nodes and synchronization logic nodes; the thread organization nodes include the FORK nodes, JOIN nodes, DETACH nodes, and EXIT nodes; the synchronization logic nodes include lock-acquisition (ACQUIRE) nodes and lock-release (RELEASE) nodes;
the other nodes are critical nodes denoting a basic operational logic of a program;
edges in the CCPG include a code property graph edge and a concurrency relationship edge;
the code property graph edge includes an abstract syntax tree edge, the control-flow edge, and a dependency edge; the concurrency relationship edge includes a thread-lifecycle edge and An May-Happens-Parallel Edges;
the thread-lifecycle edge includes an edge from the FORK node to a corresponding thread entry and edges from a thread exit to the JOIN node;
the edge indicating possible concurrent execution connects critical nodes from different threads that execute concurrently, wherein the CONCODEQL only connects and accesses the one or more critical nodes with a same memory location.

3. The concurrency vulnerability detection method based on a code concurrency property graph (CCPG) of claim 1, wherein the S3 includes:
defining the domain-specific language by a grammar L={V_{T}, V_{N}, P, S}, wherein V_{T} is a set of terminal symbols, V_{N} is a set of non-terminal symbols, P is a production rule set that serves as a primary structural unit of the grammar, the production rule set includes production rules, each production rule is expressed as α::=β, the production rules describe a process for combining elements from the terminal symbol set and non-terminal symbol set into strings, S is a start symbol;
designing the domain-specific language by utilizing and extending query statements used in a CodeQL domain-specific language; in the domain-specific language, <query> denotes the start symbol in the definition and serves as an entry point of the domain-specific language;
<var_decls> denotes a variable declaration, including a basic variable type and a built-in type <built-in type>; <condition> defines constraints within a query; <returns> specifies a value returned by the query;
wherein a domain specificity of the domain-specific language in a concurrency field is reflected in a structure <built-in type> and <concurrent_relation_condition>;
<concurrent_relation_condition> includes <access_condition>, <hb_relationship>, and <lock_condition>, configured to process the enhanced concurrent pointer analysis, the flow-sensitive happens-before analysis, and the inter-procedural lock-set analysis, respectively;
the inter-procedural lock-set analysis includes an IS_PROTECTED_BY manner and an IS_AUTOMATICALLY_PROTECTED_BY manner, the IS_PROTECTED_BY manner determines whether two variables are protected by a same lock, and the IS_AUTOMATICALLY_PROTECTED_BY manner checks whether operations are within a same critical section to ensure atomicity.

4. The concurrency vulnerability detection method based on a code concurrency property graph (CCPG) of claim 1, wherein the method includes:
determining one or more risk nodes through a risk screening algorithm based on the source code and the critical nodes, wherein the risk screening includes a memory preliminary screening algorithm, a concurrency preliminary screening algorithm, and a lock preliminary screening algorithm;
starting from a risk node, traversing the CCPG backward along the control-flow edge and a data dependency edge, in response to reaching the main entry node, constructing a risk subgraph corresponding to the risk node; and
designating one or more risk subgraphs as the CCPG and performing the S2.

5. The concurrency vulnerability detection method based on a code concurrency property graph (CCPG) of claim 4, wherein the method includes:
when the count of risk nodes exceeds a preset threshold, performing a review procedure for each risk node, wherein the review procedure includes:
for each risk node, performing a backtracking operation to obtain a memory node corresponding to the risk node;
in response to that one or more memory nodes satisfy a first preset condition, labeling the risk node;
starting from an unlabeled risk node, traversing the CCPG backward along the control-flow edge and the data dependency edge, in response to reaching the main entry node, constructing the risk subgraph corresponding to the risk node; and
designating the one or more risk subgraphs as the CCPG and proceeding to perform the S2.

6. The concurrency vulnerability detection method based on a code concurrency property graph (CCPG) of claim 1, wherein the method includes:
determining an alert level based on the vulnerability report;
in response to that the alert level exceeds an alert threshold, determining an alarm signal transmission frequency according to the alert level, and transmitting the alarm signal transmission frequency to a monitoring terminal, to control a communication interface of the monitoring terminal to send warning information to an operation and maintenance terminal at the alarm signal transmission frequency, and/or to activate warning flashing;
in response to that the alert level does not exceed the alert threshold, deploying the source code to a target server.

7. The concurrency vulnerability detection method based on a code concurrency property graph (CCPG) of claim 6, wherein the method includes:
after deploying the source code to the target server, periodically performing following operation at a preset interval:
extracting a deployed source code from the target server;
determining the vulnerability report for that deployed source code based on the deployed source code;
in response to that the vulnerability report satisfies a second preset condition, determine a target blocking port of the target server where the deployed source code is located based on the vulnerability report, controlling a switch to block the target blocking port, redirecting traffic intended for the target blocking port to a cleaning card, using the cleaning card to filter out a data packet that matches vulnerability-triggering characteristics, and forwarding the cleaned traffic back to the target server.
